(19) United States
(12) Patent Application Publication
(10) Pub. No.: US 2021/0318067 A1
(43) Pub. Date: Oct. 14, 2021

(54) ROLLER HEARTH FURNACE

(71) Applicant: SMS GROUP GMBH, Düsseldorf (DE)

(72) Inventors: Björn KINTSCHER, Velbert (DE); Karl HOEN, Asbach (DE)

(21) Appl. No.: 17/264,637

(22) PCT Filed: Jul. 26, 2019
(86) PCT No.: PCT/EP2019/070183

§ 371 Date: Jan. 29, 2021

(30) Foreign Application Priority Data
Jul. 30, 2018 (DE) 10 2018 212 703.4
Nov. 21, 2018 (DE) 10 2018 219 927.2

(51) Int. Cl. F27B 9/24; F27B 9/30

(52) U.S. Cl. CPC F27B 9/2407; F27B 9/30

(57) ABSTRACT

A roller hearth furnace, in particular a tunnel furnace of a thin-slabbing plant, including multiple cooled furnace rollers arranged in a mutually spaced manner in the transport direction in order to transport a strip or a slab have a number of support rings on a rotatably mounted axle and are formed with an insulation in the axial region between two adjacent support rings and adjacently to the respective outer support rings. The insulation is a highly insulating fiber material. Scale funnels are arranged below the furnace rollers. Scale barriers that extend transversely to the transport direction in the manner of the furnace rollers are provided in the free areas between each two successive furnace rollers in the transport direction.

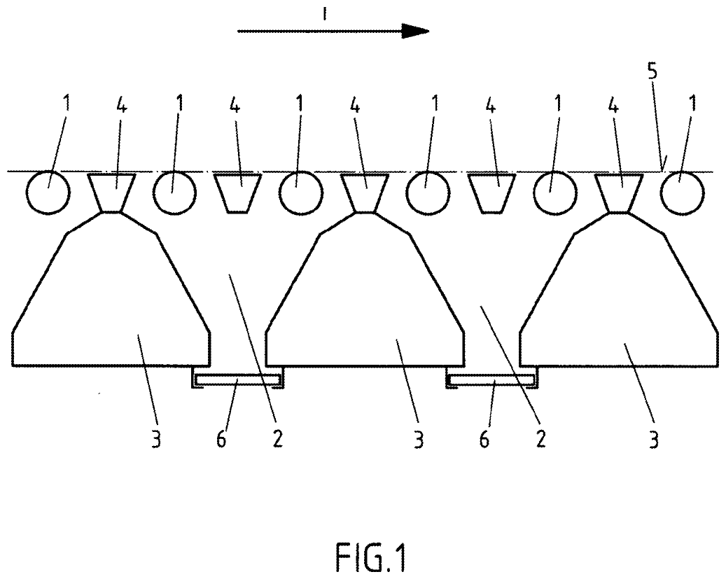

The invention relates to a roller hearth furnace, in particular a tunnel furnace of a thin slab plant, comprising a plurality of cooled furnace rollers which are arranged at a spacing from one another in a transporting direction for the transport of a strip or of a slab, said rollers having a number of support rings on a rotatably mounted axle and being configured with insulation composed of a highly insulating fiber material in the axial region between two support rings and also next to the respectively outer support rings, and scale funnels which are arranged below the furnace rollers.

Furnace rollers of this kind which are configured with insulation provided between and next to the support rings are known from WO 2018/059940 A1. A roller hearth furnace with scale funnels arranged below the furnace rollers has been disclosed, for example, by JP 64075887 A.

The known furnace rollers of a roller hearth furnace or of a tunnel furnace with support rings which transport a strip or a slab have a water cooling system in order to protect the furnace rollers against excessively high temperatures and premature failure associated therewith. The accompanying extraction of heat of the furnace or high energy consumption in the furnace, respectively, is reduced in the case of the furnace rollers by way of thermal insulation of the carrying axle, said insulation being provided next to and between the support rings and being composed of a fiber material.

The thermal insulation furthermore ensures that, on the one hand, the material to be heat-treated, strips or slabs, is not cooled to an impermissible extent and, on the other hand, the carrying axle of the furnace roller is not heated to an impermissible extent.

The furnace rollers with thermal insulation composed of a for example refractory, highly insulating fiber material or of a fiber wool, wherein the fiber material or the refractory wool preferably comprises aluminum oxide and/or silicon oxide, have a substantially lower weight than furnace rollers known in the prior art with more resistant thermal insulation composed of concrete.

In the case of the fiber-insulated furnace roller, it proves to be disadvantageous that the highly insulating fiber material or the fiber wool is attacked by flying scale or scale particles and is gradually removed or destroyed. In association therewith, the thermal insulation declines and the furnace rollers with the support rings have to be exchanged prematurely.

In the case of roller hearth furnaces with scale funnels arranged below the thermally insulated furnace rollers, the scale which comes loose during the transport of the strips or slabs by means of the support rings and which flies around in the vicinity of the furnace rollers is collected by the scale funnels and accumulated therein up to its temporary disposal.

The invention is therefore based on the object of providing, for a generic roller hearth furnace, a device with which the negative effect of scale or scale particles on the fiber material or the fiber wool can be significantly reduced and thus the service life of the fiber-insulated furnace roller can be increased.

Said object is achieved according to the invention in that scale barriers which extend, like the furnace rollers, transversely with respect to the transporting direction are provided in the free spaces between in each case two successive furnace rollers in the transporting direction.

As a result, it is advantageously achieved that the flying scale which comes loose during the transport of the material to be heat-treated is intercepted by the scale barriers and diverted into the scale funnel lying therebelow in each case. The scale can thus no longer penetrate in a destructive manner into the insulating fiber material or the insulating fiber wool of the respectively adjacent furnace roller, as a result of which the service life of the thermal insulation, and in association therewith the service life of the thermally insulated furnace roller, is increased. At the same time, the energy saving of the roller hearth furnace or tunnel furnace is ensured over a relatively long period of time.

The expression “axially adjacent to at least one of the support rings” means in particular in the axial region between two support rings and/or axially next to at least one of the outer support rings.

A preferred refinement of the invention provides for the scale barriers to be of bar-shaped configuration and to be composed of a heat-resistant material. The bar-shaped configuration of the scale barriers facilitates their simple production and arrangement between the respectively adjacent furnace rollers. The bar-shaped scale barriers are preferably manufactured from steel or refractory material or cast in the form of a molding.

According to a proposal of the invention, the scale barriers are arranged or fastened on the funnel walls which bound the scale funnels and/or in a self-supporting manner above the scale funnels.

According to a further refinement, provision is made for the scale barriers to terminate slightly below the transport plane of the furnace rollers so as not to contact the transported material. The scale barriers thus have no damaging mechanical effect on that surface of the strip or of the slab which faces toward them, but rather merely intercept and divert the loosened scale or the scale particles into the scale funnels.

Further features and details of the invention emerge from the patent claims and the following description of an exemplary embodiment which is illustrated in the drawing.

The single FIGURE shows a schematic illustration of an arrangement of cooled furnace rollers 1 which are provided in a roller hearth furnace or tunnel furnace (not illustrated). The furnace rollers 1 transport a material to be heat-treated, for example a strip or a slab, through the roller hearth furnace or tunnel furnace in a transporting direction T.

In detail, the furnace rollers 1 are configured in the manner known per se from WO 2018/059940 A1, that is to say their carrying axle is provided with thermal insulation composed of a fiber material or a fiber wool.

Scale funnels 2, which are bounded by funnel walls 3 composed of a refractory material, are provided below the furnace rollers 1.

Scale barriers 4 of bar-shaped configuration which extend transversely with respect to the transporting direction T are provided in the free spaces between the furnace rollers 1. Here, the scale barriers 4 are, on the one hand, arranged on the funnel walls 3 and, on the other hand, provided in a self-supporting manner, that is to say with a fastening at each of their bar ends, above the scale funnels 2, wherein the scale barriers 4 terminate slightly below the transport plane 5 of the furnace rollers 1 so as not to contact the transported material to be heat-treated, such that there is only a very small vertical gap between the transport plane 5 and the upper edges scale barriers 4.

The scale barriers 4 are manufactured from steel or a refractory material or cast in the form of a molding.

During the transport of the material to be heat-treated through the roller hearth furnace or tunnel furnace by means of the furnace rollers 1, scale detaches from the material to be heat-treated and then flies around in the vicinity of the furnace rollers 1 and attacks or destroys the insulation of the furnace rollers 1, said insulation being composed of fiber material or fiber wool.

This is prevented by way of the scale barriers 4 because the flying scale or scale particles is/are intercepted by the scale barriers 4 and diverted into the scale funnel 2 lying therebelow in each case, such that the scale is effectively kept away from the furnace rollers 1 lying in each case next to the scale barriers 4.

The diverting of the scale or scale particles into the scale funnels 2 by way of the scale barriers 4 is furthermore assisted by virtue of the fact that the bar-shaped scale barriers 4 are configured, on their longitudinal sides extending transversely with respect to the transporting direction T, with oblique surfaces which taper downwardly in a conical manner toward the scale funnels 2.

The scale accumulated in the scale funnels 2 can be disposed of via scale doors 6 which are provided in each case at the lower end of the scale funnels 2.

### LIST OF REFERENCE DESIGNATIONS

1 Furnace roller
2 Scale funnel
3 Funnel walls
4 Scale barrier
5 Transport plane
6 Scale door
T Transporting direction

1-4. (canceled)

5. A roller hearth furnace, comprising: a plurality of cooled furnace rollers arranged at a spacing from one another in a transporting direction for the transport of a strip or of a slab, said rollers having a plurality of support rings on a rotatably mounted axle and being provided with insulation composed of a highly insulating fiber material axially adjacent to at least one of the support rings; scale funnels arranged below the furnace rollers; and, scale barriers provided in free spaces between in each case two successive of the furnace rollers in the transporting direction, the scale barriers being arranged to extend transversely with respect to the transporting direction in a manner similar to the furnace rollers.

6. The roller hearth furnace according to claim 5, wherein the scale barriers are bar-shaped and are composed of a heat-resistant material.

7. The roller hearth furnace according to claim 5, wherein the scale funnels have funnel walls, wherein the scale barriers are arranged on the funnel walls and/or in a self-supporting manner above the scale funnels.

8. The roller hearth furnace according to claim 5, wherein the scale barriers terminate slightly below a transport plane of the furnace rollers so as not to contact the transported material.

9. The roller hearth furnace according to claim 5, wherein the roller hearth furnace is a tunnel furnace of a thin slab plant.
